(19) United States
(12) Patent Application Publication
(10) Pub. No.: US 2005/0022434 A1
(43) Pub. Date: Feb. 3, 2005

(54) Label with pocket for card insert

(76) Inventors: Jeffrey D. Kimble, Fairfield, OH (US); Lawrence W. Arway, Dayton, OH (US)

Correspondence Address: Killworth, Gottman, Hagan & Schaeff, L.L.P., Suite 500, One Dayton Centre, Dayton, OH, 45402-2023, US

(21) Appl. No.: 10/628,321

(22) Filed: Jul. 28, 2003

(51) Int. Cl. G09F 3/00; G09F 3/10

(52) U.S. Cl. 40/312; 40/638

(57) ABSTRACT

A reusable container has a card holder secured to an exterior surface thereof. The card holder includes a first ply of a film material having an upper surface and a lower surface, and a second ply of a film material having an upper surface and a lower surface. The first ply and the second ply each have substantially coextensive top and bottom edges substantially parallel to each other. The plies also have substantially coextensive first and second side edges substantially parallel to each other and substantially perpendicular to the top and bottom edges. An ultraviolet radiation curable adhesive holds the plies together, with the upper surface of the first ply in contact with the lower surface of the second ply. The curable adhesive extends around at least a portion of the periphery of the first and second plies so as to define a pocket in conjunction with the first and second plies in which an informational card may be positioned.

### CROSS REFERENCE TO RELATED APPLICATIONS

None.

### STATEMENT REGARDING FEDERALLY SPONSORED RESEARCH OR DEVELOPMENT

Not applicable.

### BACKGROUND OF THE INVENTION

The present invention relates to labels that may be adhesively applied to reusable containers. More particularly, the present invention relates to an integrated pressure sensitive label, including a pocket, that may be secured to a reusable container to facilitate use of the container. A card bearing information related to the contents of the container may be inserted in the label pocket for display during use of the container. The card may be replaced when the contents of the container are replaced.

Various types of containers are used commercially to transport or to store small component parts or other items. Containers of this type are usually made of durable material, such as plastic, and are box-shaped for compact stacking. It has been common to apply a pressure sensitive adhesive label to such a container to specify its contents and, in the case of a transport container, the location to which the container is to be delivered. Additionally, the label may provide information such as the origin of the contents, batch number, part number, serial number, quantity, and description. Once delivered and emptied of contents, the container may be reused to send or store other parts or materials. Such a reuse, of course, requires that the container be relabeled.

In order to facilitate the placement of pressure sensitive adhesive labels on the exterior of a returnable container, it has become common to apply a pliable plastic placard sheet to an exterior surface of the container. Such a placard sheet may be composed of polypropylene with a pressure sensitive adhesive on the inner side, securing it to the container, and a release coating, preferably silicone, on the outer side. Such a label system is described in U.S. Pat. No. 5,628,858, to Petrou, dated May 13, 1997, and U.S. Pat. No. 5,417,790, also to Petrou, dated May 23, 1995. Such a label arrangement provides a conspicuous label placement location and allows for re-labeling to be accomplished easily in that the adhesive of the placard sheet of the label system has a bonding strength that exceeds the adhesive bonding strength of the pressure sensitive adhesive of the labels applied to the placard sheet. In operation, a release paper backing is removed from the adhesive coating, on the placard sheet, and the placard sheet is secured by the adhesive to a selected exterior sidewall surface of a container. Thereafter, shipping or other pressure sensitive adhesive labels are applied to the silicone release coating on the outer side of the placard sheet. These labels can be removed later, as desired. The placard sheet remains on the container for use with other labels. Such a system has the disadvantage that information to be noted on a container must first be printed on a label with a pressure sensitive adhesive coating. Further, the label carrying the printed information is directly exposed to wear and tear in use, with the result that the printed information may become obscured.

Card holders having several plies with a transparent upper ply and a pocket beneath the upper ply for receiving an information bearing card have been developed for use with reusable containers. Such card holders provide protection for the cards, but may be more difficult to fabricate. Specifically, in those constructions where the multiple plies are held together with a thermally activated adhesive or where the film plies are bonded together through the application of pressure and heat to the plies, the manufacturing is slower than is desired. This slow production is a result of the amount of extended time required for the application of heat to effect a seal between the plies. This slow production process, in turn, increases the cost of production significantly.

Accordingly, a need continues for a simple arrangement for associating information with a reusable container, and for a card holder for use with an informational card in which the production of the card holder can be accomplished quickly and inexpensively.

### SUMMARY OF THE INVENTION

A cardholder according to the present invention may be employed with a reusable container to obviate the difficulties encountered in the past with regard to labeling reusable containers. The card holder includes a first ply of a film material having an upper surface and a lower surface. The cardholder further includes a second ply of a film material having an upper surface and a lower surface. The first ply and the second ply each have substantially coextensive top and bottom edges substantially parallel to each other, and substantially coextensive first and second side edges substantially parallel to each other and substantially perpendicular to the top and bottom edges. Ultraviolet radiation curable adhesive holds the plies together, with the upper surface of the first ply in contact with the lower surface of the second ply. The curable adhesive extends around at least a portion of the periphery of the first and second plies so as to define a pocket in conjunction with the first and second plies.

The film material of the first ply may be a polypropylene material, a polyester material, or a vinyl material. Similarly, the film material of the second ply may be a polypropylene material, a polyester material, or a vinyl material. A pressure sensitive adhesive is provided on the lower surface of the first ply, such that the card holder may be adhesively secured to a container surface. The pressure sensitive adhesive preferably comprises a permanent adhesive. A release ply covers the pressure sensitive adhesive on the lower surface of the first ply, such that the adhesive is covered until the cardholder is to be put into use. The release ply covering the pressure sensitive adhesive on the lower surface of the first ply defines a die cut. The die cut facilitates the removal of the release ply from the lower surface of the first ply prior to securing the card holder to a container surface.

The material making up the first ply may be an opaque film. Preferably, the material making up the first ply is a white film. The material making up the second ply preferably is a transparent film.

The present invention further contemplates a reusable container, having a card holder secured to an exterior surface of the container. The card holder includes a first ply of a film material having an upper surface and a lower surface. The cardholder further includes a second ply of a film material having an upper surface and a lower surface. The first ply and the second ply each have substantially coextensive top and bottom edges substantially parallel to each other, and substantially coextensive first and second side edges substantially parallel to each other and substantially perpendicular to the top and bottom edges. Ultraviolet radiation curable adhesive holds the plies together, with the upper surface of the first ply in contact with the lower surface of the second ply. The curable adhesive extends around at least a portion of the periphery of the first and second plies so as to define a pocket in conjunction with the first and second plies.

Accordingly, it is an object of the present invention to provide a card holder for use with a reusable container that can be easily manufactured; to provide such a card holder which is simple to use; and to provide a reusable container having such a card holder mounted on an exterior surface of the container. Other objectives of the present invention will be apparent in light of the description of the invention embodied herein.

### BRIEF DESCRIPTION OF THE SEVERAL VIEWS OF THE DRAWINGS

FIG. 1 is a plan view of the upper side of a card holder constructed according to the present invention and including an information card;

FIG. 2 is a cross-sectional view of the card holder of FIG. 1, taken generally along line 1-1 in FIG. 1, but omitting the informational card;

FIG. 3 is a plan view of the lower side of a card holder constructed according to the present invention; and

FIG. 4 is a perspective view showing a reusable container according to the present invention, having a card holder secured to an exterior surface thereof.

### DETAILED DESCRIPTION OF THE PREFERRED EMBODIMENTS

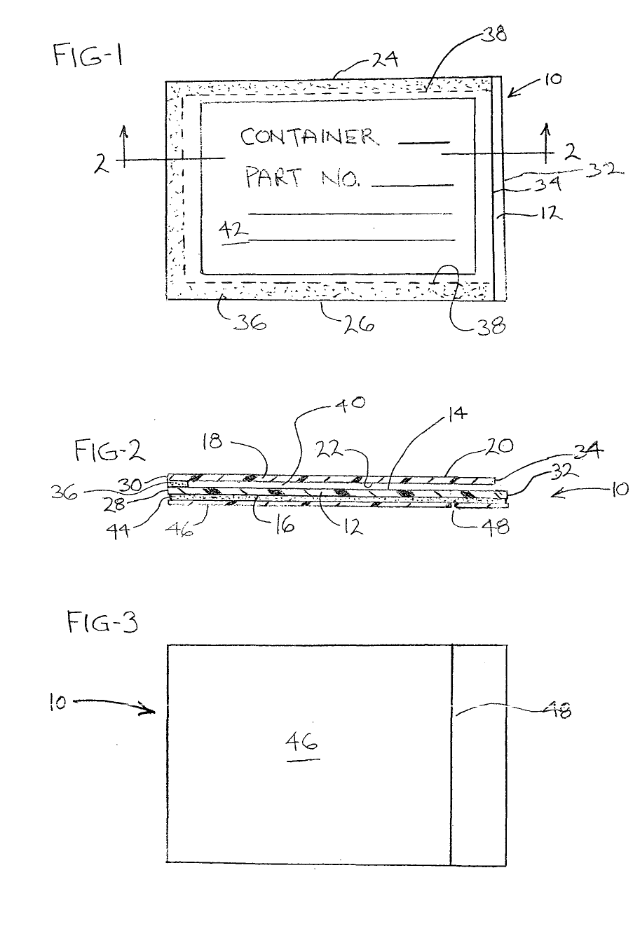

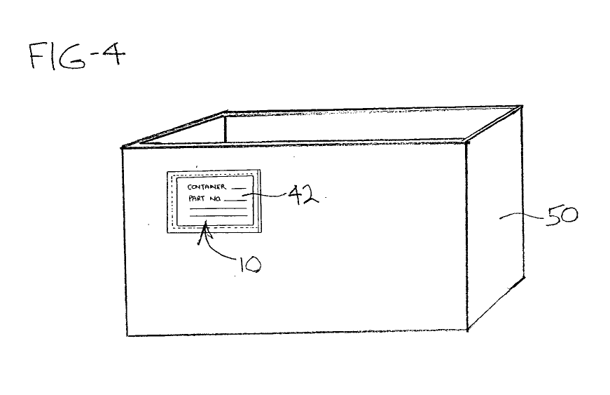

Reference is made to FIGS. 1, 2 and 3 which illustrate a card holder 10 constructed according to the present invention. The card holder includes a first ply 12 of a film material having an upper surface 14 and a lower surface 16. The film material preferably may be a polypropylene material, but a polyester material or a vinyl material may also be used. In any event, the material from which the first ply 12 is made is preferably an opaque film, and more preferably the material from which the first ply 12 is made is a white film. It will be appreciated, however, that a transparent film or a film of a color other than white may also be utilized.

The card holder further includes a second ply 18 of a film material having an upper surface 20 and a lower surface 22. The film material preferably may be a polypropylene material, but a polyester material or a vinyl material may also be used. The material from which the second ply 18 is made is a transparent film. Although polypropylene, polyester and vinyl materials are preferred for the film materials from which plies 12 and 18 are made, other film materials may also be used for either of these plies. For example, appropriately selected polystyrene, polyethylene, and polyolefin materials may also he used for plies 12 and 18.

The first ply 12 and the second ply 18 each have substantially coextensive top and bottom edges, indicated at 24 and 26, respectively, which are substantially parallel to each other. The first ply 12 and the second ply 18 have substantially coextensive first side edges 28 and 30, respectively, and second side edges 32 and 34, respectively, that are substantially parallel to each other and substantially perpendicular to the top and bottom edges 24 and 26.

The card holder further includes an ultraviolet radiation curable adhesive 36 that holds plies 12 and 18 together. As seen in FIG. 2, the upper surface 14 of the first ply 12 is held in contact with the lower surface 22 of the second ply 18 by the curable adhesive 36. As illustrated in FIG. 1, and as represented by the dashed line 38 and stippled area between line 38 and the margin of the card holder, the radiation curable adhesive 36 extends around at least a portion of the periphery of the first and second plies 12 and 18 so as to define a pocket 40 in conjunction with these plies. An informational card 42 is positioned within the pocket 40. Informational card 42 is omitted from FIG. 2 to simplify the figure. Printed and written information on card 43 may be viewed through transparent ply 18.

Note that the edges 32 and 34 are not aligned, as shown in FIG. 2, but that edge 34 is slightly offset with respect to edge 32. This arrangement facilitates inserting an informational card 42 into pocket 40. As shown in the drawings, access to the pocket 40 is through the opening adjacent edges 32 and 34. It will be appreciated, however, that the adhesive may be omitted from along another portion of the periphery of the card holder to permit a card 42 to be inserted into, or withdrawn from, the pocket 40.

The card holder 10 further comprises a pressure sensitive adhesive 44 on the lower surface 16 of the first ply 12, such that the card holder may be adhesively secured to a container surface. Prior to applying the card holder 10 to the surface of a container, the adhesive 44 is covered by a release ply 46. The release ply 46 is preferably a known release material, such as for example a paper stock having a silicone coating which prevents the adhesive 44 from permanently engaging the release ply. The release ply 46 defines a die cut or slit 48 which extends across the ply. The die cut 48 facilitates the removal of the release ply 46 from the adhesive 44 on the lower surface 16 of the first ply 12 prior to securing the card holder 10 to a container surface. When the release ply 46 is removed from the card holder 10 to expose the adhesive 44, which is preferably a permanent adhesive, the cardholder may be permanently secured to the container surface.

As seen in FIG. 4, the card holder 10 is secured to an exterior surface of a reusable container 50. The informational card 42 in the pocket 40 of the holder 10 provides information with respect to the items that are stored in the reusable container 50. The card holder 10 is rugged in construction and is capable of extended usage on the container, with the informational card 42 being replaced as often as necessary to reflect the content of the container accurately. The transparent ply 18 permits the information printed on card 42 to be read easily without removing the card from the pocket 40. Further, the transparent ply 18 also permits the adhesive 36 to be cured by the application of ultraviolet radiation after the plies of the card holder 10 are assembled.

It will be appreciated that the use of an adhesive that is cured by means of exposure to ultraviolet radiation through the ply 18 greatly increases the speed with which card holders according to the present invention can be manufactured. Such adhesives can be exposed to UV radiation for whatever period of time is required in the manufacturing process to effect a cure without reducing the rate at which the card holders leave the production equipment. If a longer cure time is required, then the length of the UV exposure equipment through which the card holders pass can simply be increased. On the other hand, using a heat curable adhesive for bonding film plies, or bonding film plies with direct bonding between film layers produced by the application of heat and pressure, require that the production equipment supplying the pressure and/or heat have a significant dwell time. This in turn limits the number of card holders that can be produced in a given amount of time. It will be appreciated, therefore, that the present invention permits the card holder to be manufactured efficiently, more quickly, and therefore more economically.

It will be appreciated that the reusable container constructed according to the present invention with a card holder secured to an exterior surface, as depicted in FIG. 4, has numerous uses. Such a container may be used for storing parts or transporting parts. The informational card 42 may be easily replaced when the contents of the container are changed. Access to the pocket 40 is facilitated for this purpose since second side edges 32 and 34 are not precisely aligned, with edge 34 offset slightly to the left of edge 32, as depicted in FIGS. 1 and 2. The user lifts the ply 18 slightly away from ply 12 adjacent edge 34, and inserts or extracts a card 42.

The die cut or slit 48 facilitates the removal of the release ply 46 from the adhesive 44 prior to securing the card holder 10 to a container surface. The user simply flexes the card holder 10 adjacent the die cut 48, and the edges of the release ply 46 along the die cut flex upward, allowing the release ply 46 to be peeled manually from the lower surface of the first ply of film material 12.

Having described the invention in detail and by reference to preferred embodiments thereof, it will be apparent that modifications and variations are possible without departing from the scope of the invention defined in the appended claims.

1. A card holder, comprising:
a first ply of a film material having an upper surface and a lower surface,
a second ply of a film material having an upper surface and a lower surface, said first ply and said second ply each having substantially coextensive top and bottom edges substantially parallel to each other, and substantially coextensive first and second side edges substantially parallel to each other and substantially perpendicular to said top and bottom edges, and
ultraviolet radiation curable adhesive holding said plies together with the upper surface of said first ply in contact with the lower surface of said second ply, said curable adhesive extending around at least a portion of the periphery of said first and second plies so as to define a pocket in conjunction with said first and second plies.

2. The card holder of claim 1, in which said film material of said first ply is a polypropylene material.

3. The card holder of claim 1, in which said film material of said second ply is a polypropylene material.

4. The card holder of claim 1, in which said film material of said first ply is a polyester material.

5. The card holder of claim 1, in which said film material of said second ply is a polyester material.

6. The card holder of claim 1, in which said film material of said first ply is a vinyl material.

7. The card holder of claim 1, in which said film material of said second ply is a vinyl material.

8. The card holder of claim 1 further comprising a pressure sensitive adhesive on the lower surface of said first ply, such that said card holder may be adhesively secured to a container surface.

9. The card holder of claim 8 further comprising a release ply covering said pressure sensitive adhesive on the lower surface of said first ply.

10. The card holder of claim 9 in which said release ply covering said pressure sensitive adhesive on the lower surface of said first ply defines a die cut or slit, said die cut or slit facilitating the removal of said release ply from said lower surface of said first ply prior to securing said card holder to a container surface.

11. The card holder of claim 8 in which said pressure sensitive adhesive comprises a permanent adhesive.

12. The card holder of claim 1, in which said material making up said first ply is an opaque film.

13. The card holder of claim 12, in which said material making up said first ply is a white film.

14. The card holder of claim 1, in which said material making up said second ply is a transparent film.

15. A reusable container, having a card holder secured to an exterior surface thereof, said card holder comprising:
a first ply of a film material having an upper surface and a lower surface,
a second ply of a film material having an upper surface and a lower surface, said first ply and said second ply each having substantially coextensive top and bottom edges substantially parallel to each other, and substantially coextensive first and second side edges substantially parallel to each other and substantially perpendicular to said top and bottom edges, and
ultraviolet radiation curable adhesive holding said plies together with the upper surface of said first ply in contact with the lower surface of said second ply, said curable adhesive extending around at least a portion of the periphery of said first and second plies so as to define a pocket in conjunction with said first and second plies in which an informational card may be positioned.

16. The reusable container of claim 15, in which said film material of said first ply is a polypropylene material.

17. The reusable container of claim 15, in which said film material of said second ply is a polypropylene material.

18. The reusable container of claim 15, in which said film material of said first ply is a polyester material.

19. The reusable container of claim 15, in which said film material of said second ply is a polyester material.

20. The reusable container of claim 15, in which said film material of said first ply is a vinyl material.

21. The reusable container of claim 15, in which said film material of said second ply is a vinyl material.

22. The reusable container of claim 15 further comprising a pressure sensitive adhesive on the lower surface of said first ply, such that said card holder is adhesively secured to said exterior surface of said container.

23. The reusable container of claim 22 in which said pressure sensitive adhesive comprises a permanent adhesive.

24. The reusable container of claim 15, in which said material making up said first ply is an opaque film.

25. The reusable container of claim 24, in which said material making up said first ply is a white film.

26. The reusable container of claim 15, in which said material making up said second ply is a transparent film.

27. The reusable container of claim 15 further comprising an informational card in said pocket, providing information with respect to the items in said reusable container.
